(19) United States
(12) Patent Application Publication
(10) Pub. No.: US 2021/0390479 A1
(43) Pub. Date: Dec. 16, 2021

(54) VEHICLE ALLOCATION PLAN DEVICE, VEHICLE ALLOCATION PLAN SYSTEM, AND VEHICLE ALLOCATION PLAN PROGRAM

(71) Applicant: TOYOTA JIDOSHA KABUSHIKI KAISHA, Toyota-shi (JP)

(72) Inventors: Shoji ITOH, Nagoya-shi (JP); Masaru ARAKI, Toyota-shi (JP); Satofumi KURISU, Nagoya-shi (JP)

(73) Assignee: TOYOTA JIDOSHA KABUSHIKI KAISHA, Toyota-shi (JP)

(21) Appl. No.: 17/324,231

(22) Filed: May 19, 2021

(30) Foreign Application Priority Data
Jun. 16, 2020 (JP) 2020-103870

(51) Int. Cl. G06Q 10/06; G08G 1/00; G06Q 50/30; G01C 21/34

(52) U.S. Cl. CPC G06Q 10/06313; G08G 1/202; G01C 21/343; G06Q 10/06315; G06Q 50/30

(57) ABSTRACT

A vehicle allocation acceptance unit accepts, from a client terminal, delivery request information including at least a departure location and a destination location of cargo and/or passengers. A vehicle allocation candidate derivation unit derives a vehicle allocation candidate having a vehicle and a route determined, based on the accepted delivery request information and vehicle information which is collected b a vehicle information collection unit. A vehicle allocation plan determination unit determines a. vehicle allocation plan from among vehicle allocation candidates derived by the vehicle allocation candidate derivation unit. Specifically, the vehicle allocation plan is determined such that the vehicle is, within a predetermined time range, located in a partial area where several regions are in contact with each other.

### CROSS-REFERENCE TO RELATED APPLICATION

This application claims priority to Japanese Patent Application No. 2020-103870 filed on Jun. 16, 2020, incorporated herein by reference in its entirety.

### BACKGROUND

### 1. Technical Field

The present disclosure relates to a vehicle allocation plan device, a vehicle allocation plan system, and a vehicle allocation plan program, each of which is used to make a vehicle allocation plan.

### 2. Description of Related Art

Japanese Unexamined Patent Application Publication 2018-181372 disclosed an information processing apparatus and a program, each of which is capable of improving the convenience of searching for products on a website of an online supermarket.

In particular, a search-start instruction acceptance unit is configured to determine a phrase entered in an input field as a search term to be used for the search, and to accept a search-start instruction. Furthermore, a product-name candidate display unit is configured to extract product names including the text entered in the input field as a part of product information from a product master, and display the extracted names at the bottom of the input field as candidates for a product name that a user wants to search for prior to the search--start instruction. A search--term acceptance unit is configured to accept selection of the product name that the user wants to search for, from among the candidates for the product name. A search unit is configured to execute a search process based on the candidate for the product name accepted by the search-term acceptance unit.

### SUMMARY

However, the online supermarket, as disclosed in Japanese Unexamined Patent Application Publication 2018-181372, can often only be used by consumers in a limited area, i.e., near a store where the product is stocked. There is also a social problem in that elderly people in depopulated areas without online supermarket services, and who cannot drive, are likely to be inconvenienced, i.e., they cannot buy what they need or want. Therefore, an appropriate solution is required for improved or enhanced transportation that allows items and even persons to be carried in a wider range.

The present disclosure provides a vehicle allocation plan device, a vehicle allocation plan system, and a vehicle allocation plan program, each of which is capable of carrying persons or goods over a wide range including a plurality of regions.

According to a first aspect of the present disclosure, a vehicle allocation plan device includes an acceptance unit configured to accept transportation request information including respective locations of a departure point and an arrival point for a transportation target, and a creation unit configured to acquire vehicle information including location information of a plurality of vehicles, each of which travels in each of a plurality of regions within a range from the departure point to the arrival point, and create a vehicle allocation plan such that a vehicle is located, within a predetermined time range, in an area where the plurality of regions are in contact with each other, based on the acquired location information and the transportation request information which is accepted by the acceptance unit.

In the vehicle allocation plan device according to the first aspect, the acceptance unit accepts the transportation request information including the respective locations of the departure point and the arrival point for the transportation target.

The creation unit acquires vehicle information including the location information of the plurality of vehicles, each of which travels in each of the plurality of regions within the range from the departure point to the arrival point, and creates the vehicle allocation plan such that the vehicle is located, within the predetermined time range, in the area where the plurality of regions are in contact with each other, based on the acquired location information and the transportation request information which is accepted by the acceptance unit. Consequently, the vehicles in the plurality of regions can cooperate with each other to transport cargo and passengers, whereby persons and goods can be carried over a wider range including a plurality of regions.

In the first aspect, the vehicle may be a taxi, and the creation unit may create the vehicle allocation plan such that, in a case where the transportation target is a person, the taxi transports the person beyond a region at which the taxi offers services and which includes the departure point, and in a case where the taxi returns from the arrival point to the region including the departure point, the transportation target is limited to goods. Accordingly, it is possible to transport cargo and passengers by a taxi which offers services in areas designated for each region.

In the first aspect, the creation unit may derive a plurality of vehicle dispatch candidates, each of which having a vehicle and a route, determined for transportation according to a predetermined precondition, and create the vehicle allocation plan by determining, based on a predetermined condition, a vehicle dispatch candidate from among the derived vehicle dispatch candidates. In the first aspect, the creation unit may determine the vehicle dispatch candidate from among the plurality of vehicle dispatch candidates, based on at least one of transportation efficiency and a time required for transportation, as the predetermined condition. Accordingly, it is possible to create the vehicle allocation plan suitable for the predetermined condition.

According to a second aspect of the present disclosure, a vehicle allocation plan system includes the vehicle allocation plan device outlined above, a client terminal that generates transportation request information and transmits such information to the vehicle allocation plan device, and a vehicle-side terminal mounted on the vehicle and having functions of transmitting vehicle information and receiving a vehicle allocation plan created by the vehicle allocation plan device.

In the vehicle allocation plan system according to the second aspect, the client terminal generates the transportation request information and transmits such information to the vehicle allocation plan device, and the vehicle-side terminal transmits the vehicle information to the vehicle allocation plan device. Therefore, the vehicle allocation plan device can create the vehicle allocation plan as stated above.

By transmitting the vehicle allocation plan created by the vehicle allocation plan device to the vehicle-side terminal, a driver of the vehicle can transport the transportation target according to the vehicle allocation plan. Consequently, the vehicles in the plurality of regions can cooperate with each other to transport cargo and passengers, whereby persons and goods can be carried over a wider range including a plurality of regions.

A third aspect of the present disclosure is a vehicle allocation plan program that causes a computer to function as each component of the vehicle allocation plan device.

With the present disclosure, it is possible to provide the vehicle allocation plan device, the vehicle allocation plan system, and the vehicle allocation plan program, each of which is capable of carrying persons or goods over a wide range including a plurality of regions.

### BRIEF DESCRIPTION OF THE DRAWINGS

Features, advantages, and technical and industrial significance of exemplary embodiments of the present disclosure will be described below with reference to the accompanying drawings, in which like signs denote like elements, and wherein:

FIG. 1 is a diagram illustrating a schematic configuration of a vehicle allocation plan system according to an embodiment of the present disclosure;

FIG. 2 is a block diagram illustrating a main configuration of an electric system of each of a vehicle allocation plan server, a service management server, a client terminal, and a vehicle-side terminal;

FIG. 3 is a functional block diagram illustrating a functional configuration of the vehicle allocation plan server according to the present embodiment;

FIG. 4 is a diagram illustrating regions A to E as examples of a service area;

FIG. 5 is a flowchart illustrating an example of a process flow executed by the vehicle allocation plan server of the vehicle allocation plan system according to the present embodiment;

FIG. 6 is a diagram illustrating precondition of an exemplified vehicle allocation plan;

FIG. 7 is a diagram illustrating a draft of a standard plan for a vehicle allocation candidate;

FIG. 8 is a diagram illustrating a first draft for the vehicle allocation candidate;

FIG. 9 is a diagram illustrating a second draft for the vehicle allocation candidate;

FIG. 10 is a diagram illustrating a third draft for the vehicle allocation candidate;

FIG. 11 is a diagram illustrating a fourth draft for the vehicle allocation candidate; and

FIG. 12A, FIG. 12B, FIG. 12C, FIG. 12D and FIG. 12E are diagrams illustrating detailed calculation results for the draft of the standard plan of the vehicle allocation candidate and respective vehicle dispatch candidates of the first to fourth drafts.

### DETAILED DESCRIPTION OF EMBODIMENTS

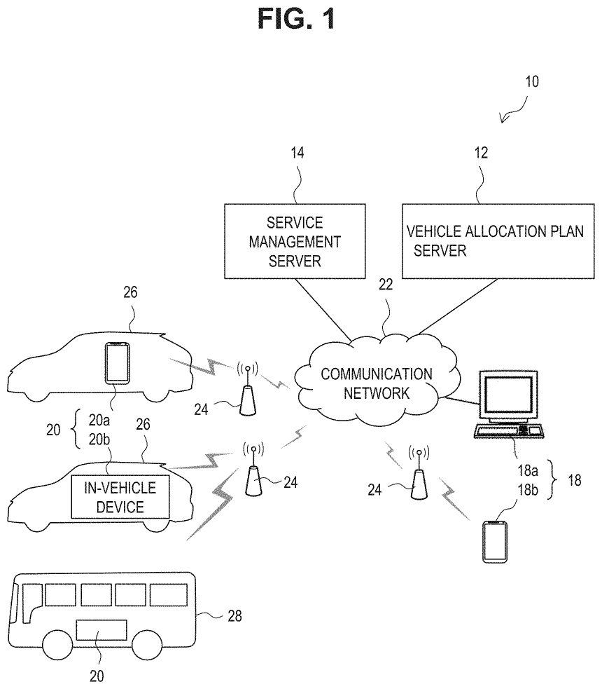

Hereinafter, one exemplified embodiment of the present disclosure will be described in detail with reference to drawings. FIG. 1 is a diagram illustrating a schematic configuration of a vehicle allocation plan system according to an embodiment of the present disclosure.

As shown in FIG. 1, a vehicle allocation plan system 10 according to the present embodiment includes a vehicle allocation plan server 12 as a vehicle allocation plan device, a service management server 14, a client terminal 18, and a vehicle-side terminal 20, each of which is connected to a communication network 22.

The vehicle allocation plan server 12 executes processes of accepting, from a user, previously registered vehicle dispatch request information for transporting a transportation target including persons or goods, creating a vehicle allocation plan, and distributing the created plan for a vehicle to be dispatched. Furthermore, the vehicle allocation plan server 12 collects and compiles various pieces of information on the vehicle dispatch into a database for management of vehicle dispatch. Examples of various pieces of information compiled as the database include information collected from the user and vehicle information collected from the vehicle. Examples of the information collected from the user include user data, purpose of use, reservation data (including a dispatch location as a departure point, a destination location as an arrival point, and date/time when the vehicle dispatch is required), cancellation history (e.g. date/time when the cancellation is made), and survey results (e.g. satisfaction index). Available pieces of information, from among these pieces of information collected from the user, are collected and compiled as the database. Examples of the information collected from the vehicle include a service history, such as a time when a dispatch instruction is received, the dispatch location, the destination location, a date/time when the transportation target is picked up (a date/time when the vehicle dispatch is completed), and a date/time when the transportation target is dropped off (a date/time when the vehicle arrives). Available information, from among these pieces of information collected from the vehicle, is collected and compiled as the database.

The service management server 14 collects and complies various pieces of vehicle information that can be collected from the vehicle, such as a taxi 26 or a bus 28, into a database for management of a service status. Examples of the vehicle information collected from the vehicle include location information of the vehicle, destination information, information on cargo loaded on the vehicle and/or passengers traveling in the vehicle, region information on a region where the vehicle offers services, traveling data, driving operation data, residual energy data, and equipment operation data on doors or other equipment. Available pieces of information, from among these pieces of information collected from the vehicle, are collected and compiled as the database.

The client terminal 18 serves as an interface that accesses the vehicle allocation plan server 12 and receives a service provided by the vehicle allocation plan server. In particular, a request is made to the vehicle allocation plan server 12 to transport persons and/or goods. The client terminal 18 generates the transportation request information including respective locations of the departure point and the arrival point and transmits such information to the vehicle allocation plan server 12, as operated by the user. For example, as shown in FIG. 1, a personal computer 18a, a portable terminal 18b (such as a smartphone or a tablet terminal), a smart TV, or the like may be adopted as the client terminal 18. When the portable terminal 18b is employed, it is connected to the communication network 22 via a wireless relay station 24.

The vehicle-side terminal 20 is mounted on the vehicle to be dispatched, such as the taxi 26 or the bus 28, and has functions of transmitting, to the service management server 14, the vehicle information including the location information of the vehicle, and receiving a vehicle allocation plan created by the vehicle allocation plan server 12. For example, as shown in FIG. 1, a portable terminal 20a (such as a smartphone or a tablet terminal) or a dedicated in-vehicle device 20b having a call function and a function of transceiving information may be adopted as the vehicle-side terminal 20. As the dedicated in-vehicle device 20b, for example, a dedicated in-vehicle device called a data communication module (DCM) may be employed.

A main configuration of an electrical system of each of the vehicle allocation plan server 12, the service management server 14, the client terminal 18, and the vehicle-side terminal 20, included in the vehicle allocation plan system 10 according to the present embodiment, will be described hereinbelow.

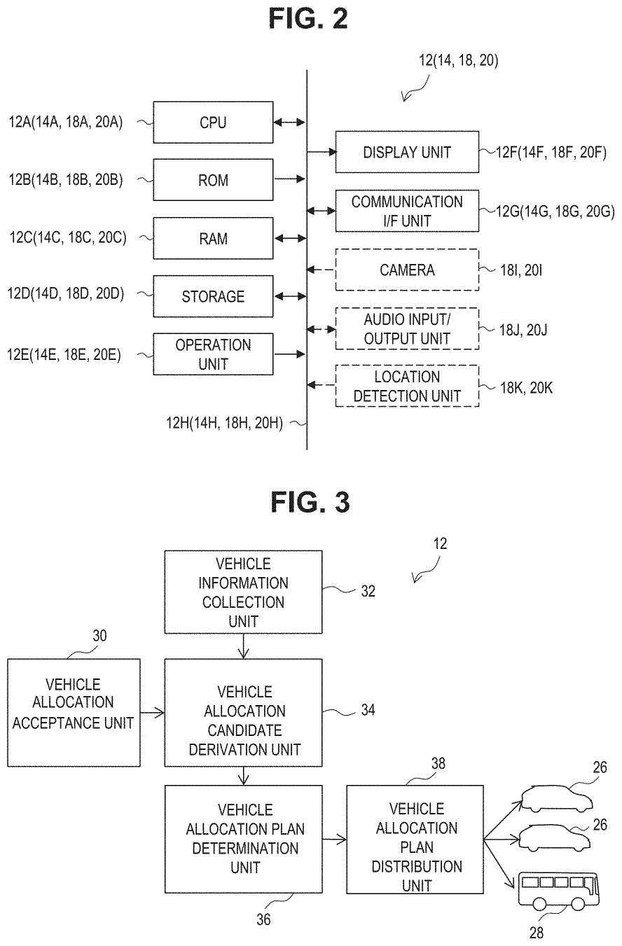

FIG. 2 is a block diagram illustrating the main configuration of the electric system of each of the vehicle allocation plan server 12, the service management server 14, the client terminal 18, and the vehicle-side terminal 20. Since the vehicle allocation plan server 12, the service management server 14, the client terminal 18, and the vehicle-side terminal 20 are basically configured as general computers, the vehicle allocation plan server 12 will be described as a representative example.

As shown in FIG. 2, the vehicle allocation plan server 12 includes a central processing unit (CPU) 12A, a read only memory (ROM) 12B, a random access memory (RAM) 12C, a storage 12D, an operation unit 12E, a display unit 12F, and a communication interface (I/F) unit 12G.

The CPU 12A is a central arithmetic processing unit that functions as the acceptance unit and the creation unit, and controls overall operation of the device by executing various programs. Various control programs and parameters are previously stored in the ROM 12B. The RAM 12C is used as a work area when executing various programs by the CPU 12A. The storage 12D is configured by various storage units such as a hard disk drive (HDD), a solid state drive (SSD), and a flash memory, in which various data and application programs are stored. The operation unit 12E is configured by a keyboard, a mouse, a touchscreen, and the like, and is used for inputting various information. The display unit 12F is used to display various types of information. The communication I/F unit 12G can be connected to the communication network 22 such as LAN, WAN, the Internet, and various networks, and transmits and receives various data to and from other devices connected to the communication network 22. Components of the vehicle allocation plan server 12 are electrically connected to each other by a system bus 12H.

With the configuration stated above, the vehicle allocation plan server 12 causes the CPU 12A to access the ROM 12B, the RAM 12C, and the storage 12D, acquire various data via the operation unit 12E, and display various information on the display unit 12F. Furthermore, the vehicle allocation plan server 12 causes the CPU 12A to control transmission and reception of the communication data via the communication I/F unit 12G.

The client terminal 18 and vehicle-side terminal 20 may further include cameras 18I and 20I, audio input/output units 18J and 20J, and location detection units 18K and 20K, respectively, as shown by dotted lines in FIG. 2.

The camera 181 or 201 captures a still image or a moving image so as to generate image data representing the moving image or the still image.

The voice input/output unit 18J or 20J outputs voice from a speaker, headphones or the like, inputs voice by collecting sound with a microphone or the like, and generates voice information representing the input voice.

The location detection unit 18K or 20K detects current location information of the client terminal 18 and the vehicle-side terminal 20. For example, the location is detected by receiving radio waves from global positioning system (GPS) satellites and positioning one point in a space based on distances from three or more GPS satellites.

One example of a function executed by the CPU 12A of expanding the program stored in the ROM 12B to the RAM 12C and executing the program will be described hereinbelow. FIG. 3 is a functional block diagram illustrating a functional configuration of the vehicle allocation plan server 12 according to the present embodiment.

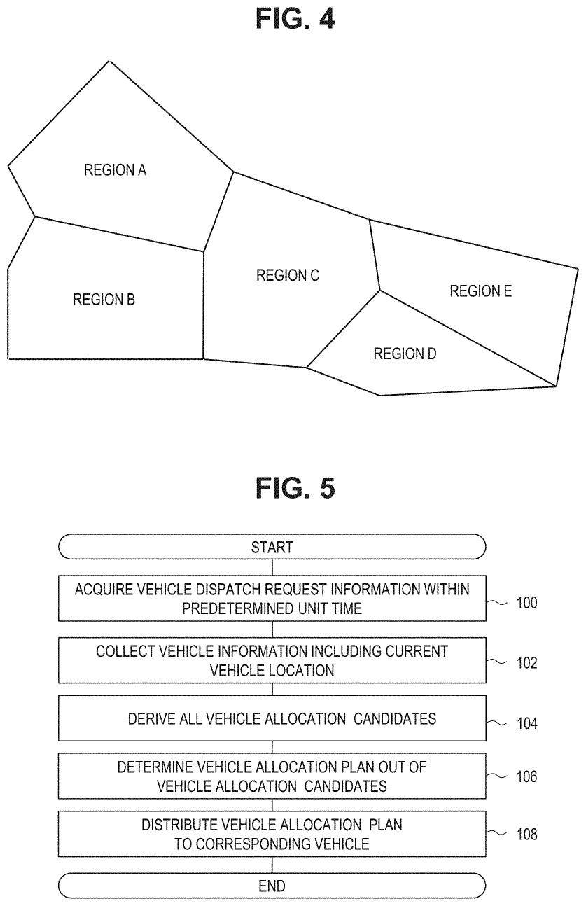

As shown in FIG. 3, the vehicle allocation plan server 12 has functions of a vehicle allocation acceptance unit 30, a vehicle information collection unit 32, a vehicle allocation candidate derivation unit 34, a vehicle allocation plan determination unit 36, and a vehicle allocation plan distribution unit 38. The vehicle allocation acceptance unit 30 corresponds to the acceptance unit, and both or one of the vehicle allocation candidate derivation unit 34 and the vehicle allocation plan determination unit 36 correspond to the creation unit. The vehicle allocation plan server 12 executes processes of accepting, from the client terminal 18, the vehicle dispatch request information representing a request for transporting cargo and/or passengers, creating vehicle allocation plans for the vehicles, each plan encompassing respective regions from the departure location to the destination location, and distributing the created vehicle allocation plan to each vehicle. Consequently, it is possible to carry persons and goods over a wider range including a plurality of regions. Additionally, in a case where there are several service areas where the vehicle, such as the taxi 26 and the transit bus 28, offers services, the service areas being partially in contact or overlapping with each other, and each service area has a specific service provider, the service plan is created in consideration of taking over cargo and/or passengers. Specifically, in a case where a purchased product is delivered, and several service areas of the taxi 26 or the bus 28 exist between a store that has the product for which the delivery is requested by the user and a delivery destination, the vehicle allocation plan is created such that the product will be handed over at a partial area of the service area within a predetermined time range (for example, 16:00 to 16:10). For example, in a case where the service area of the taxi 26 or the bus 28 is previously determined for each of the regions A to E, as shown in FIG. 4, the vehicle allocation plan is created such that the product will be handed over at a partial area where the regions are in contact with each other. For the service area of the taxi 26, the vehicle allocation plan may be created in consideration of flows of persons and goods such that, for example, the taxi carries persons when leaving the service area and transports deliveries when traveling back to the service area.

The vehicle allocation acceptance unit 30 accepts, from the client terminal 18, delivery request information including at least a location of the departure location (as the departure point), and a location of the destination location (as the arrival point), of cargo and/or passengers. That is, the delivery request information is accepted by receiving the delivery request information input by the user operating the client terminal 18 via the communication network 22.

The vehicle information collection unit 32 collects previously registered information on vehicles to be dispatched, such as taxi companies and bus companies for each region, via the service management server 14. That is, in the present embodiment, the service management server 14 collects the vehicle information of each vehicle to be dispatched, and the vehicle information collection unit 32 acquires the vehicle information collected by the service management server 14. The vehicle information (e.g. the location information of the vehicle, the destination information, the information on cargo loaded on the vehicle and/or passengers riding in the vehicle, and the region information on the region where the vehicle offers services) is acquired from the service management server 14 via the communication network 22.

The vehicle allocation candidate derivation unit 34 derives a vehicle allocation candidate in which vehicles and a route are determined, based on the delivery request information accepted by the vehicle allocation acceptance unit 30 and the vehicle information collected by the vehicle information collection unit 32. For example, the vehicle allocation candidate derivation unit 34 derives all vehicles and routes of vehicle dispatch candidates from the departure location to the destination location included in the delivery request information, as the vehicle dispatch candidates. Furthermore, for each of the vehicle dispatch candidates, information for the vehicle dispatch candidate (such as a travel distance or a time required for delivery) is derived. When the taxi 26 is a vehicle of the vehicle dispatch candidate, the vehicle allocation candidate derivation unit 34 may derive the vehicle allocation candidate such that, in a case where the transportation target is a person, the taxi transports the person beyond a region including the departure point, and in a case where the taxi returns from the arrival point to the region including the departure point, the transportation target is limited to goods. Consequently, even if the taxi company's service area is restricted, it is possible to carry goods over a wide range, as well as transporting persons in the same way as a typical taxi business.

The vehicle allocation plan determination unit 36 determines the vehicle allocation plan from among the vehicle allocation candidates derived by the vehicle allocation candidate derivation unit 34. Specifically, the vehicle allocation plan is determined such that the vehicle is located, within the predetermined time range, at a partial area where the several regions are in contact with each other. Specifically, in a case where the vehicle having the fixed service area, such as the taxi 26 or the bus 28, is included in the vehicle dispatch candidate, the vehicle allocation plan is determined such that the vehicle is located at a partial area where the several regions are in contact with each other within the predetermined time range. In a case where several vehicle allocation candidates are derived by the vehicle allocation candidate derivation unit, the vehicle allocation plan determination unit 36 determines the vehicle allocation candidate satisfying predetermined condition as the vehicle allocation plan.

The vehicle allocation plan distribution unit 38 distributes the vehicle allocation plan to the vehicle-side terminal 20 of the vehicle, such as the taxi 26 or the bus 28, which is included in the vehicle allocation plan determined by the vehicle allocation plan determination unit 36. That is, the vehicle allocation plan is transmitted to each of the vehicles to be dispatched via the communication network 22. The vehicle allocation plan may be directly distributed from the vehicle allocation plan server 12 to each of the vehicles via the communication network 22, or may be distributed to each of the vehicles via the service management server 14. Consequently, the vehicle allocation plan is received by the vehicle-side terminal 20 of each vehicle, and the driver of each vehicle can offer services in accordance with the vehicle allocation plan. In a case where the vehicle allocation plan is distributed to each vehicle via the service management server 14, the driver may be informed via, for example, wireless communication, instead of the communication network 22.

A specific process executed by the vehicle allocation plan server 12 of the vehicle allocation plan system 10 according to the present embodiment, configured as stated above, will be described hereinbelow. FIG. 5 is a flowchart illustrating an example of a process flow executed by the vehicle allocation plan server 12 of the vehicle allocation plan system 10 according to the present embodiment. The process of FIG. 5 is executed every, for example, predetermined unit time (for example, 1 to 3 hours).

In step 100, the CPU 12A acquires the vehicle dispatch request information within the predetermined unit time. The process proceeds to step 102. In the present embodiment, the vehicle allocation plan server 12 does not create the vehicle allocation plan every time it receives the vehicle dispatch request information, but every predetermined unit time by collecting the vehicle dispatch requests for such a unit time (for example, 1 to 3 hours), thus the vehicle allocation acceptance unit 30 acquires the vehicle dispatch requests within the unit time.

In step 102, the CPU 12A collects the vehicle information including the current vehicle location. The process proceeds to step 104. That is, the vehicle information collection unit 32 collects previously registered information on vehicles to be dispatched, such as taxi companies and bus companies for each region, via the service management server 14. In the present embodiment the vehicle information collection unit 32 acquires the vehicle information collected by the service management server 14.

In step 104, the CPU 12A derives all vehicle allocation candidates. The process proceeds to step 106. That is, the vehicle allocation candidate derivation unit 34 derives the vehicle allocation candidates, based on the delivery request information accepted by the vehicle allocation acceptance unit 30 and the vehicle information collected by the vehicle information collection unit 32. For example, the vehicle allocation candidate derivation unit 34 derives all vehicles and routes of vehicle dispatch candidates from the departure location to the destination location included in the delivery request information, as the vehicle dispatch candidates. Furthermore, for each of the vehicle dispatch candidates, information for the vehicle dispatch candidate (such as a travel distance or a time required for delivery) is derived. Furthermore, when the taxi 26 is the vehicle of the vehicle dispatch candidate and the vehicle allocation candidate derivation unit 34 derives the vehicle dispatch candidate, the vehicle allocation candidate may be derived such that the taxi transports the person beyond a region including the departure point where the taxi offers services, and in a case where the taxi returns from the arrival point to the region including the departure point, the transportation target is limited to goods. Consequently, even if the taxi company's service area is restricted, it is possible to carry goods over a wide range, as well as transport persons in the same way as a typical taxi business.

In step 106, the CPU 12A determines the vehicle allocation plan from among the vehicle allocation candidates derived by the vehicle allocation candidate derivation unit 34. The process proceeds to step 108. That is, the vehicle allocation plan determination unit 36 determines the vehicle allocation plan, by determining the vehicle allocation candidate from among the vehicle allocation candidates derived by the vehicle allocation candidate derivation unit 34. For example, in a case where the vehicle having the fixed service area, such as the taxi 26 or the bus 28, is included in the vehicle allocation candidates, the vehicle allocation plan is created such that the vehicle is located, within the predetermined time range, in a partial area where the several regions are in contact with each other. Furthermore, in a case where several vehicle allocation candidates are derived by the vehicle allocation candidate derivation unit, the vehicle allocation plan determination unit 36 determines the vehicle allocation candidate satisfying predetermined condition as the vehicle allocation plan. Examples of the predetermined condition include the shortest delivery time, the shortest delivery distance, the minimum number of vehicles allocated, and the like.

In step 108, the CPU 12A distributes the vehicle allocation plan to the corresponding vehicles. The process ends. That is, the vehicle allocation plan distribution unit 38 distributes the vehicle allocation plan to the vehicle-side terminal 20 of the vehicle, such as the taxi 26 or the bus 28, which is included in the vehicle allocation plan determined by the vehicle allocation plan determination unit 36. Consequently, the vehicle allocation plan is received by the vehicle-side terminal 20 of each vehicle, and the driver of each vehicle can offer services in accordance with the vehicle allocation plan. Accordingly, the vehicles in the plurality of regions can cooperate with each other to transport cargo and passengers, whereby persons and goods can be carried over a wide range.

In the process of FIG. 5, the example is described wherein the vehicle allocation plan server 12 creates the vehicle allocation plan for the vehicle dispatch requests collected for the predetermined unit time, but the present disclosure is not limited thereto. For example, the vehicle allocation plan server 12 may create the vehicle allocation plan every time it receives the vehicle dispatch request information.

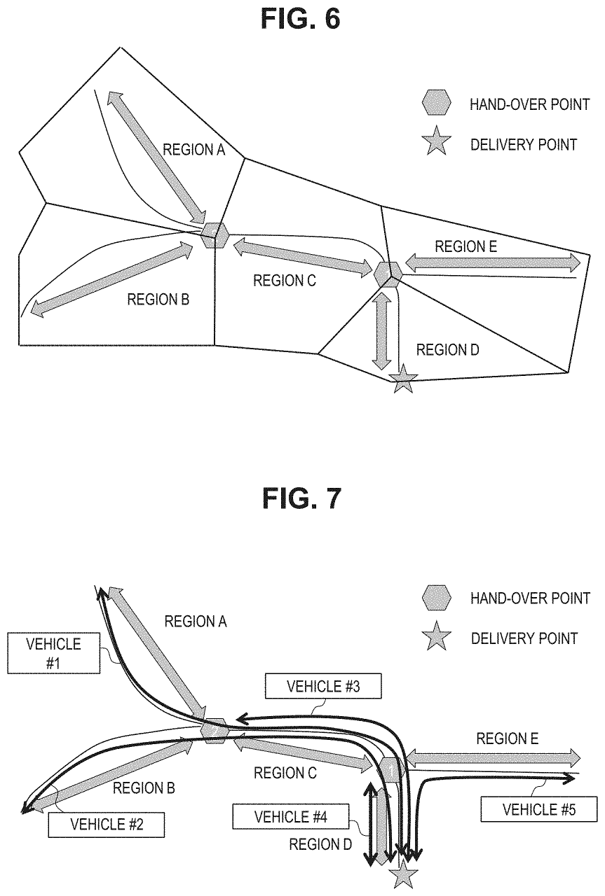

The vehicle allocation plan executed by the vehicle allocation plan server 12 of the vehicle allocation plan system 10 according to the present embodiment will be specifically described referring to one example. FIG. 6 is a diagram illustrating precondition of the exemplified vehicle allocation plan.

For example, as shown in FIG. 6, a case will be described where the product has to be delivered from the store and the vehicle allocation plan is created for the regions A to E. In the example of FIG. 6, a star in the region D is a delivery point at which delivery is started, a partial area where the regions C to E are in contact with each other is a hand-over point 1, and a partial area where the regions A to C are in contact with each other is a hand-over point 2.

The vehicle allocation plan server 12 plans, in principle, vehicle dispatch in accordance with the delivery requests per hour of the respective regions A to E.

Additionally, since the order of the highest volume of packages to be transported is region D>region C>regions A, B and E, taking into account the transportation volume, vehicles of the regions C and E are additionally dispatched to the region D, and vehicles of the regions A and B are additionally dispatched to the region C. Consequently, it is possible to flexibly respond to an increase or decrease in the transportation volume. In a case where a vehicle of the region other than the region including the departure location is additionally dispatched, a vehicle to be dispatched and a time when delivery is started from the delivery point are adjusted such that the vehicle is located, within the predetermined time range, at the hand-over point in the partial area where the regions are in contact with each other.

Furthermore, when accepting delivery of the product, a take-over time can be optimized by adjusting a delivery available time in each region. A delivery available time is adjusted by, for example, displaying the delivery available time for each region to the user when the user is accepting the vehicle dispatch request information. If the user requested a time which is shorter than the delivery available time, the delivery request cannot be accepted. For example, in the example shown in FIG. 6, the delivery available time for each region is adjusted so as to establish the order of region D→region E and C→regions A and B. Therefore, it is possible to reduce the take-over time at each hand-over point.

It is assumed that the following requests are received, four requests in the region A, three requests in the region B, three requests in the region C, five requests in the region D, and two requests in the region E. The precondition is that a distance (main route in section) is set to 1 for the section D, 2 for the section A, 1.5 for the section B, 1.5 for the section C, and 2.5 for the section E. Additionally, the number of vehicles that can be used is set to 5, and the maximum transportation volume per vehicle is set to 4 people or 8 packages (2 packages per seat). Furthermore, a traveling time per distance unit is 30, a delivery time per unit (time required for from travel to delivery) is 10, and a hand-over/take-over time per unit is 1.

Moreover, as a restriction, the user is notified of a period of time of delivery in which five vehicles can offer services as the time when the delivery request is made. A delivery request not falling within the period of time of delivery is not accepted.

Depending on the predetermined precondition and the restrictions, the vehicle allocation candidate derivation unit 34 of the vehicle allocation plan server 12 derives vehicle allocation candidate, each of which having a vehicle and a route, determined for transportation.

In particular, the vehicle allocation candidate derivation unit 34 first creates the delivery plan where one vehicle does not deliver the products in several sections and no hand-over occurs, as a draft of a standard plan serving as a reference of the vehicle allocation candidate. FIG. 7 is a diagram illustrating the draft of the standard plan for the vehicle allocation candidate.

In the draft of the standard plan, the vehicle which will deliver in the order of region D, C, and A is considered to be the vehicle #1. The vehicle #1 loads four packages at the delivery point and delivers four packages in the region A.

Furthermore, the vehicle which will deliver in the order of region D, region C, and B is considered to be the vehicle #2. The vehicle #2 loads three packages at the delivery point and delivers three packages in the region B.

The vehicle which will deliver in the order of region D and C is considered to be the vehicle #3. The vehicle #3 loads three packages at the delivery point and delivers three packages in the region C.

The vehicle which will deliver in the region D is considered to be the vehicle #4. The vehicle #4 loads five packages at the delivery point and delivers five packages in the region D.

The vehicle which will deliver in the order of region D and E is considered to be the vehicle #5. The vehicle #5 loads two packages at the delivery point and delivers two packages in the region E.

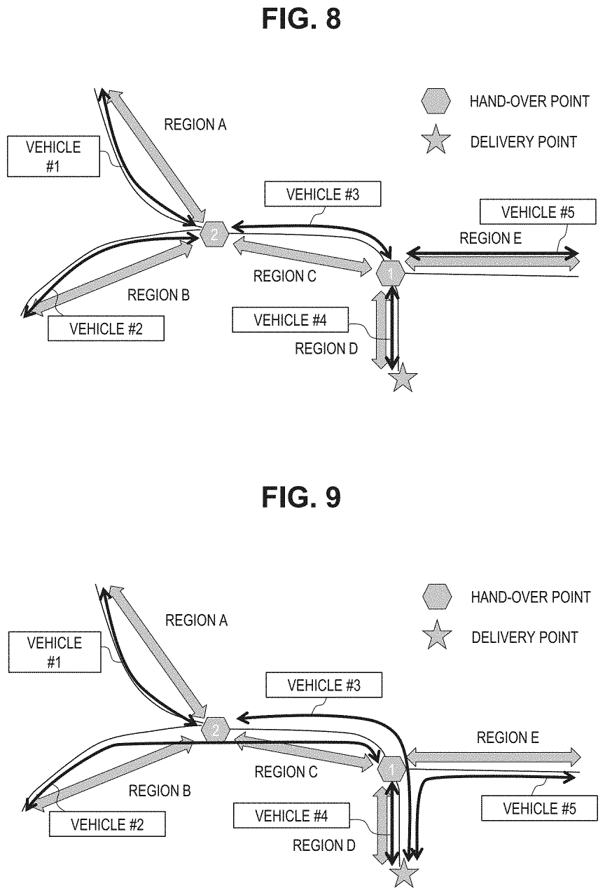

The vehicle allocation candidate derivation unit 34 plans, as a first draft of the vehicle allocation candidate, the vehicle dispatch in which transportation in each section is carried out first, and then the packages are handed over at the hand-over points. FIG. 8 is a diagram illustrating the first draft for the vehicle allocation candidate.

In the first draft, the vehicle that delivers in the region A is the vehicle #1, the vehicle that delivers in the region B is the vehicle #2, the vehicle that delivers in the region C is the vehicle #3, the vehicle that delivers in the region D is the vehicle #4, and the vehicle that delivers in the region E is the vehicle #5.

The vehicle #1 takes four packages from the vehicle #3 at the hand-over point 2 and delivers four packages in the region A. The vehicle #2 takes three packages from the vehicle #3 at the hand-over point 2 and delivers three packages in the region B. The vehicle #3 takes ten packages from the vehicle #4 at the hand-over point 1, delivers three packages in the region C, moves to the hand-over point 2, and hands over four packages to the vehicle #1 and three packages to the vehicle #2. The vehicle #4 carries 17 packages at the delivery point, delivers five packages in the region D, moves to the hand-over point 1, and hands over ten packages to the vehicle #3 and two packages to the vehicle #5. The vehicle #5 takes two packages from the vehicle #4 at the hand-over point 1 and delivers two packages in the region E.

In the first draft, the total transportation volume in the region D is 17, which means more than two vehicles (17/8) are required, thus this draft is rejected. Additionally, based on the total transportation volume, at least three vehicles in the region D and at least two vehicles in the region C are required.

The vehicle allocation candidate derivation unit 34 plans, as a second draft of the vehicle allocation candidate, the vehicle dispatch in which the vehicles in the regions E and C, sections adjacent to the region D in the first draft, share transportation targets with the vehicle #4, and the vehicle in the region B, a section adjacent to the region C, shares transportation targets with the vehicle #3. FIG. 9 is a diagram illustrating the second draft for the vehicle allocation candidate. In the second draft, in a case where there are multiple adjacent sections, the same transportation volume is allocated for each of the adjacent sections. However, if the total transportation volume exceeds the maximum transportation volume, the second draft will be excluded. In an example shown in FIG. 9, the transportation volume of the vehicle #5 is shared with the vehicle #2.

In the second draft, the vehicle that delivers in the region A is the vehicle #1, the vehicle that delivers in the order of region C and B is the vehicle #2, the vehicle that delivers in the order of region D and C is the vehicle #3, the vehicle that delivers in the region D is the vehicle #4, and the vehicle that delivers in the order of region D and E is the vehicle #5.

The vehicle #1 takes four packages from the vehicle #3 at the hand-over point 2 and delivers four packages in the region A. The vehicle #2 takes three packages from the vehicle #5 at the hand-over point 1 and delivers three packages in the region B. The vehicle #3 carries seven packages at the delivery point, delivers three packages in the region C, moves to the hand-over point 1, and hands over four packages to the vehicle #1. The vehicle #4 carries five packages at the delivery point and delivers five packages in the region D. The vehicle #5 carries five packages at the delivery point, moves to the hand-over point 1, hands over three packages to the vehicle #2, and delivers two packages in the region E.

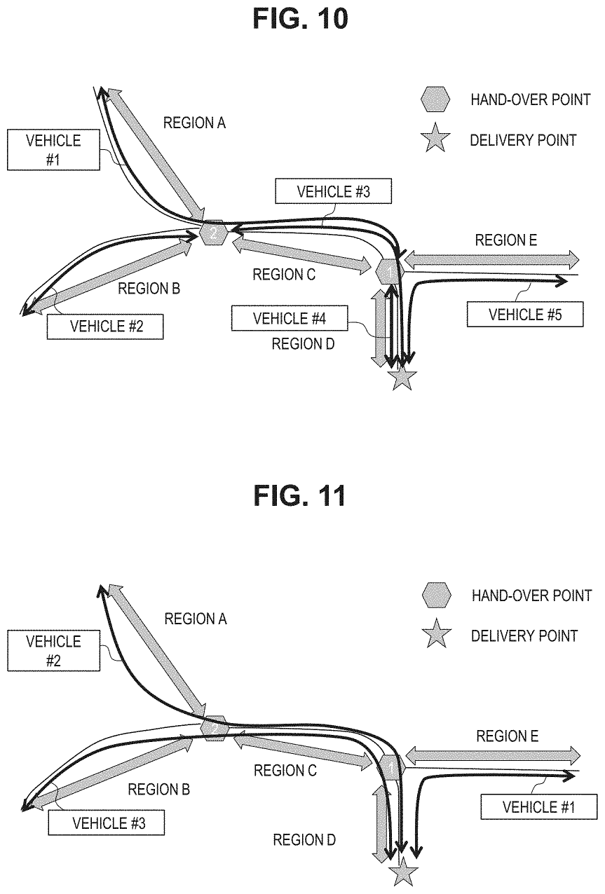

The vehicle allocation candidate derivation unit 34 plans, as a third draft of the vehicle allocation candidate, similar to the second draft, the vehicle dispatch in which the vehicles in the regions E and C, sections adjacent to the region D in the first draft, share transportation targets with the vehicle #4, and the vehicle in the region A, a section adjacent to the region C, shares transportation targets with the vehicle #3. FIG. 10 is a diagram illustrating the third draft for the vehicle allocation candidate.

In the third draft, the vehicle that delivers in the order of region C and A is the vehicle #1, the vehicle that delivers in the region B is the vehicle #2, the vehicle that delivers in the order of region D and C is the vehicle #3, the vehicle that delivers in the region D is the vehicle #4, and the vehicle that delivers in the order of region D and E is the vehicle #5.

The vehicle #1 takes four packages from the vehicle #5 at the hand-over point 1 and delivers four packages in the region A. The vehicle #2 takes three packages from the vehicle #3 at the hand-over point 2 and delivers three packages in the region B. The vehicle #3 carries six packages at the delivery point, delivers three packages in the region C, moves to the hand-over point 2, and hands over three packages to the vehicle #2. The vehicle #4 carries five packages at the delivery point and delivers five packages in the region D. The vehicle #5 carries six packages at the delivery point, moves to the hand-over point 1, hands over four packages to the vehicle #1, and delivers two packages in the region E.

The vehicle allocation candidate derivation unit 34 plans, as a fourth draft of the vehicle allocation candidate, the vehicle dispatch, in a case where all sections of the regions A to E are passed at least once, no hand-over occurs, each vehicle has a transportation volume that does not exceed the maximum volume, and no delivery vehicle is in the overlapping sections (C and D). FIG. 11 is a diagram illustrating the fourth draft for the vehicle allocation candidate. The draft in FIG. 11 is an example, and is a delivery sharing in which total coverage is the smallest and a maximum value of a final time required for all vehicles to complete delivery is the smallest, from among all of the drafts.

The vehicle #1 carries seven packages at the delivery point, and delivers five packages in the region D and two packages in the region E. The vehicle #2 carries four packages at the delivery point and delivers four packages in the region A. The vehicle #3 carries six packages at the delivery point, and delivers three packages in the region C and three packages in the region B.

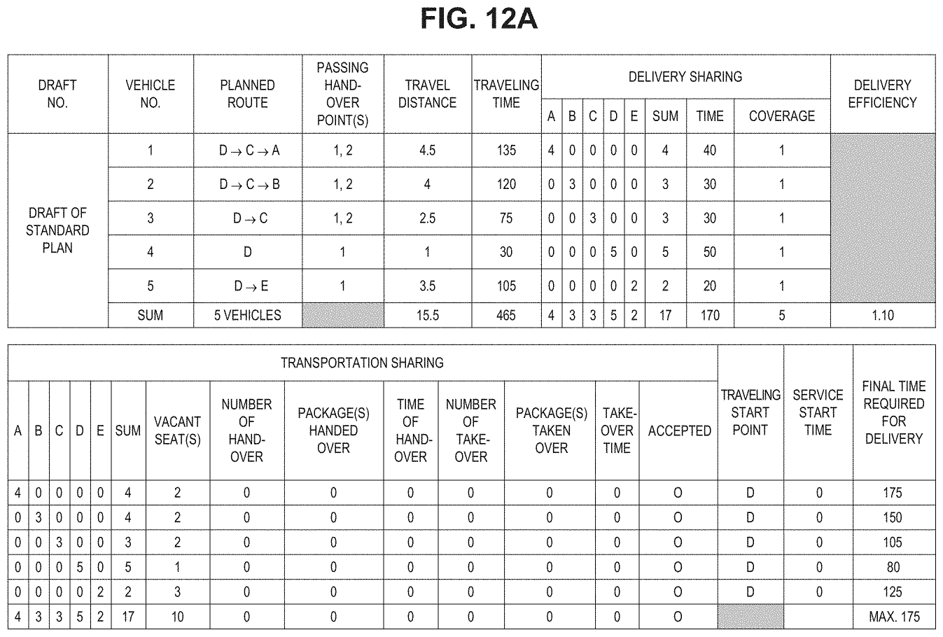

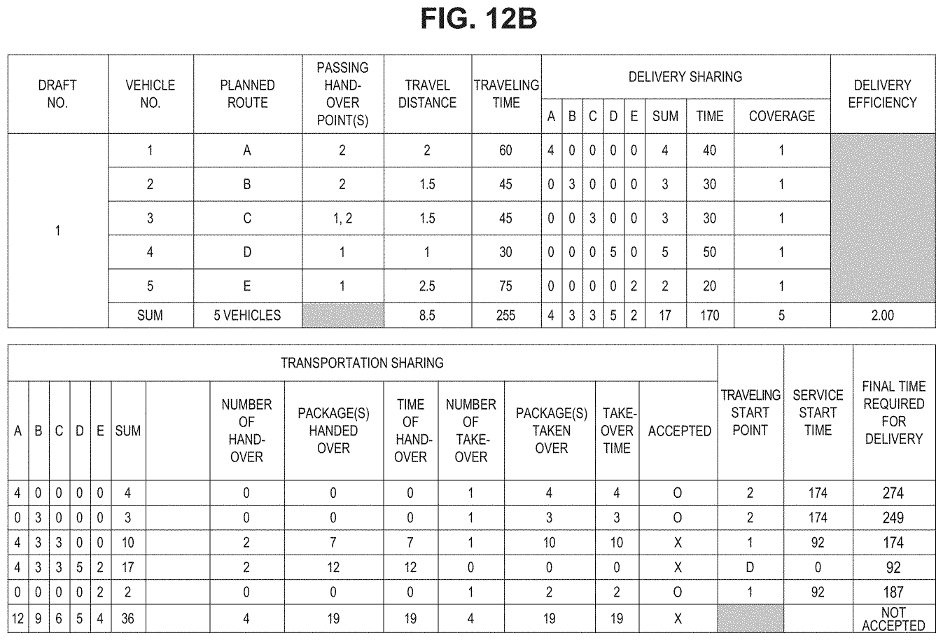

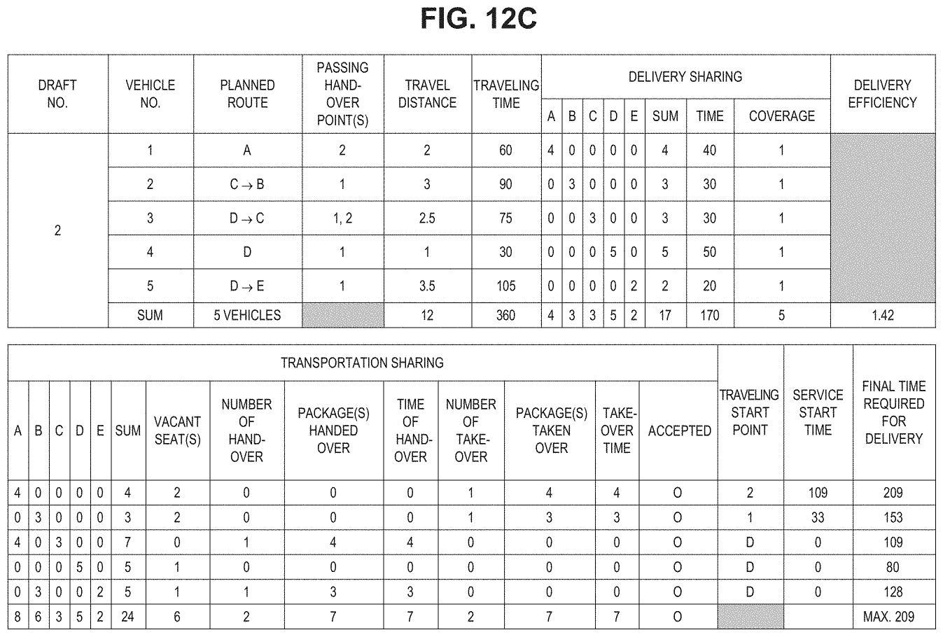

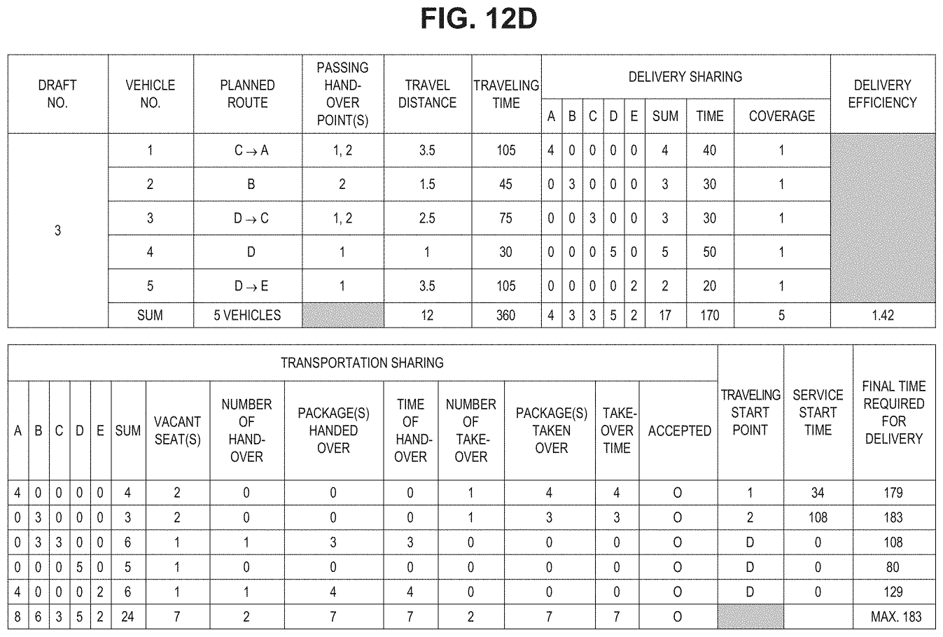

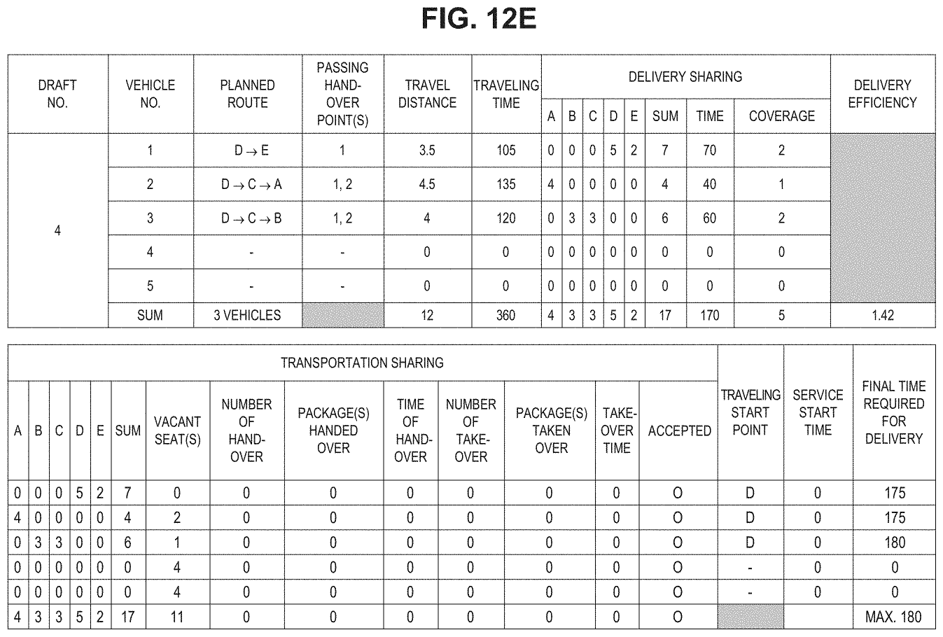

Subsequently, based on the precondition stated above, the vehicle allocation candidate derivation unit 34 derives, for each of the vehicle dispatch candidates, information for the vehicle dispatch candidate (such as a travel distance or a time required for delivery). As one example, FIG. 12A, FIG. 12B, FIG. 12C, FIG. 12D and FIG. 12E show detailed calculation results for the draft of a standard plan of the vehicle dispatch candidate and respective vehicle dispatch candidates of the first to fourth drafts. FIG. 12A, FIG. 12B, FIG. 12C, FIG. 12D and FIG. 12E are diagrams illustrating detailed calculation results for the draft of the standard plan of the vehicle allocation candidate and respective vehicle dispatch candidates of the first to fourth drafts.

FIG. 12A, FIG. 12B, FIG. 12C, FIG. 12D and FIG. 12E show detailed calculation results including vehicle number, planned route, passing hand-over point(s), travel distance, traveling time, delivery sharing, delivery efficiency, transportation sharing, traveling start point, service start time, and final time required for delivery. The delivery sharing indicates the delivery volume in each region A to E, and indicates sum, time, and coverage. The delivery efficiency indicates the delivery volume per distance and is one of the evaluation indexes of the draft of the plan. Furthermore, the transportation sharing indicates the transportation volume including the hand-over volume in each of regions A to E, and indicates sum, number of vacant seat(s), number of hand-overs, number of package(s) handed over, hand-over time, number of take-overs, package(s) taken over, take-over time, and whether the delivery request is acceptable.

Specifically, as shown in FIG. 12A, the vehicle #1 of the draft of the standard plan has a planned route of D→C→A, passing hand-over point(s) 1 and 2, with a travel distance of 4.5, and a traveling time of 135, and delivery sharing is 4 in region A, i.e., a sum of 4, a time of 40 and a coverage of 1. The transportation sharing is “acceptable” with 4 in region A, i.e., a sum of 4, 2 vacant seats, no hand-overs, no packages handed over, a hand-over time of 0, no take-overs, no packages taken over, and a take-over time of 0. The service start point is D, the service start time is 0, and the final time required for delivery is 175.

The vehicle #2 of the draft of the standard plan has a planned route of D→C→B, passing hand-over point(s) 1 and 2, with a travel distance of 4, and a traveling time of 120, and delivery sharing is 3 in region B, i.e., a sum of 3, a time of 30, and a coverage of 1. The transportation sharing is “acceptable” with 3 in region B, i.e., a sum of 3, 2 vacant seats, no hand-overs, no packages handed over, a hand-over time of 0, no take-overs, no packages taken over, a take-over time of 0. The service start point is D, the service start time is 0, and the final time required for delivery is 150.

The vehicle #3 of the draft of the standard plan has a planned route of D→C, passing hand-over point(s) 1 and 2, with a travel distance of 2.5, and a traveling time of 75, and delivery sharing is 3 in region C, i.e., a sum of 3, a time of 30, and a coverage of 1. The transportation sharing is “acceptable” with 3 in region C, i.e., a sum of 3, 2 vacant seats, no hand-overs, no packages handed over, a hand-over time of 0, no take-overs, no packages taken over, and a take-over time of 0. The service start point is D, the service start time is 0, and the final time required for delivery is 105.

The vehicle #4 of the draft of the standard plan has a planned route of D, passing hand-over point(s) 1, with a travel distance of 1, and a traveling time of 30, and delivery is 5 in region D, i.e., a sum of 5, a time of 50 and a coverage of 1. The transportation sharing is “acceptable” with 5 in region D, i.e., a sum of 5, 1 vacant seat, no hand-overs, no packages handed over, a hand-over time of 0, no take-overs, no packages taken over, and a take-over time of 0. The service start point is D, the service start time is 0, and the final time required for delivery is 80.

The vehicle #5 of the draft of the standard plan has a planned route of D→E, passing hand-over point(s) 1 with a travel distance of 3.5, and a traveling time of 105, and delivery sharing is 2 in region E, i.e., a sum of 2, a time of 20 and a coverage of 1. The transportation sharing is “acceptable” with 2 in region E, i.e., a sum of 2, 3 vacant seats, no hand-overs, no packages handed over, a hand-over time of 0, no take-overs, no packages taken over, and a take-over time of 0. The service start point is D, the service start time is 0, and the final time required for delivery is 125.

In the draft of the standard plan, as shown in FIG. 12A, 5 vehicles in total are required, with a total travel distance of 15.5, a total traveling time of 465, delivery sharing is 4 at A, 3 at B, 3 at C, 5 at D, 2 at E, i.e., a total sum of 17, a total time of 170, a total coverage of 5, and a delivery efficiency of 1.10. The total transportation sharing is 17, with 4 at A, 3 at B, 3 at C, 5 at D and 2 at E. Moreover, the transportation sharing has 10 vacant seats in total, 0 hand-overs in total, 0 packages handed over in total, a total hand-over time of 0, 0 take-overs in total, 0 packages taken over in total, a total take-over time of 0, and a maximum value of a final time required for delivery of 175.

The vehicle #1 of the first draft has a planned route of A, passing hand-over point(s) 2 with a travel distance of 2, and a traveling time of 60, and delivery sharing is 4 in region A, i.e., a sum of 4, a time of 40, and a coverage of 1. The transportation sharing is “acceptable” with 4 in region A, i.e., a sum of 4, no hand-overs, no packages handed over, a hand-over time of 0, 1 take-over, 4 packages taken over, and a take-over time of 4. The service start point is the hand-over point 2, the service start time is 174, and the final time required for delivery is 274.

The vehicle #2 of the first draft has a planned route of B, passing hand-over point(s) 2, with a travel distance of 1.5, and a traveling time of 45, and delivery sharing is 3 in region B, i.e., a sum of 3, a time of 30, and a coverage of 1. The transportation sharing is “acceptable” with 3 in region B, i.e., a sum of 3, no hand-overs, no packages handed over, a hand-over time of 0, 1 take-over, 3 packages taken over, and a take-over time of 3. The service start point is the hand-over point 2, the service start time is 174, and the final time required for delivery is 249.

The vehicle #3 of the first draft has a planned route of C, passing hand-over point(s) 1 and 2, with a travel distance of 1.5, and a traveling time of 45, and delivery sharing is 3 in region C, i.e., a sum of 3, a time of 30, and a coverage of 1. The transportation sharing is “not acceptable” with 4 in region A, 3 in region B, and 3 in region C, i.e., a sum of 10, 2 hand-overs, 7 packages handed over, a hand-over time of 7, 1 take-over, 10 packages taken over, and a take-over time of 10. The service start point is the hand-over point 1, the service start time is 92, and the final time required for delivery is 174.

The vehicle #4 of the first draft has a planned route of D, passing hand-over point(s) 1, with a travel distance of 1, and a traveling time of 30, and delivery sharing is 5 in region D, i.e., a sum of 5, a time of 50, and a coverage of 1. The transportation sharing is “not acceptable” with 4 in region A, 3 in region B, 3 in region C, 5 in region D, and 2 in region E, i.e., a sum of 17, 2 hand-overs, 12 packages handed over, a hand-over time of 12, no take-overs, no packages taken over, and a take-over time of 0. The service start point is D, the service start time is 0, and the final time required for delivery is 92.

The vehicle #5 of the first draft has a planned route of E, passing hand-over point(s) 1, with a travel distance of 2.5, and a traveling time of 75, and delivery sharing is 2 in region E, i.e., a sum of 2, a time of 20, and a coverage of 1. The transportation sharing is “acceptable” with 2 in region E, i.e., a sum of 2, no hand-overs, no packages handed over, a hand-over time of 0, 1 take-over, 2 packages taken over, and a take-over time of 2. The service start point is the hand-over point 1, the service start time is 92, and the final time required for delivery is 187.

In the first draft, as shown in FIG. 12B, 5 vehicles in total are required, with a total travel distance of 8.5, a total traveling time of 255, and delivery sharing is 4 at A, 3 at B, 3 at C, 5 at D, 2 at E, i.e., a total sum of 17, a total time of 170, a total coverage of 5 and a delivery efficiency of 2.00. The total transportation sharing is 36 with 12 at A, 9 at B, 6 at C, 5 at D and 4 at E. Moreover, the transportation sharing is “not acceptable” with 4 hand-overs in total, 19 packages handed over in total, a total hand-over time of 19, 4 take-overs in total, 19 packages taken over in total, and a total take-over time of 19. Therefore, the first draft is not acceptable.

The vehicle #1 of the second draft has a planned route of A, passing hand-over point 2, with a travel distance of 2, and a traveling time of 60, and delivery sharing is 4 in region A, i.e., a sum of 4, a time of 40, and a coverage of 1. The transportation sharing is “acceptable” with 4 in region A, i.e., a sum of 4, 2 vacant seats, no hand-overs, no packages handed over, a hand-over time of 0, 1 take-over, 4 packages taken over, and a take-over time of 4. The service start point is the hand-over point 2, the service start time is 109, and the final time required for delivery is 209.

The vehicle #2 of the second draft has a planned route of C→B, passing hand-over point 1, with a travel distance of 3, and a traveling time of 90, and delivery sharing is 3 in region B, i.e., a sum of 3, a time of 30, a coverage of 1. The transportation sharing is “acceptable” with 3 in region B, i.e., a sum of 3, 2 vacant seats, no hand-overs, no package handed over, a hand-over time of 0, 1 take-over, 3 packages taken over, and a take-over time of 3. The service start point is the hand-over point 1, the service start time is 33, and the final time required for delivery is 153.

The vehicle #3 of the second draft has a planned route of D→C, passing hand-over points 1 and 2, with a travel distance of 2.5, and a traveling time of 75, and delivery sharing is 3 in region C, i.e., a sum of 3, a time of 30, and a coverage of 1. The transportation sharing is “acceptable” with 4 in region A and 3 in region C, i.e., a sum of 7, no vacant seats, 1 hand-over, 4 packages handed over, a hand-over time of 4, no take-overs, no packages taken over, and a take-over time of 0. The service start point is D, the service start time is 0, and the final time required for delivery is 109.

The vehicle #4 of the second draft has a planned route of D, passing hand-over point 1, with a travel distance of 1, and a traveling time of 30, and delivery sharing is 5 in region D, i.e., a sum of 5, a time of 50, and a coverage of 1. The transportation sharing is “acceptable” with 5 in region D, i.e., a sum of 5, 1 vacant seat, no hand-overs, no packages handed over, a hand-over time of 0, no take-overs, no packages taken over, and a take-over time of 0. The service start point is D, the service start time is 0, and the final time required for delivery is 80.

The vehicle #5 of the second draft has a planned route of D→E, passing hand-over point 1, with a travel distance of 3.5, and a traveling time of 105, and delivery sharing is 2 in region E, i.e., a sum of 2, a time of 20, and a coverage of 1. The transportation sharing is “acceptable” with 3 in region B and 2 in region E, i.e., a sum of 5, 1 vacant seat, 1 hand-over, 3 packages handed over, a hand-over time of 3, no take-overs, no packages taken over, and a take-over time of 0. The service start point is D, the service start time is 0, and the final time required for delivery is 128.

In the second draft, as shown in FIG. 12C, 5 vehicles in total are required, with a total travel distance of 12, and a total traveling time of 360, and delivery sharing is 4 at A, 3 at B, 3 at C, 5 at D, 2 at E, i.e., a total sum of 17, a total time of 170, a total coverage of 5, and a delivery efficiency of 1.42. The total transportation sharing is 24 with 8 at A, 6 at B, 3 at C, 5 at D and 2 at E. Moreover, the transportation sharing has 6 vacant seats in total, 2 hand-overs in total, 7 packages handed over in total, a total hand-over time of 7, 2 take-overs in total, 7 packages taken over in total, a total take-over time of 7, and a maximum value of a final time required for delivery of 179.

The vehicle #1 of the third draft has a planned route of C→A, passing hand-over points 1 and 2, with a travel distance of 3.5, and a traveling time of 105, and delivery sharing is 4 in region A, i.e., a sum of 4, a time of 40, and a coverage of 1. The transportation sharing is “acceptable” with 4 in region A, i.e., a sum of 4, 2 vacant seats, no hand-overs, no packages handed over, a hand-over time of 0, 1 take-over, 4 packages taken over, and a take-over time of 4. The service start point is the hand-over point 1, the service start time is 34, and the final time required for delivery is 179.

The vehicle #2 of the third draft has a planned route of B, passing hand-over point 2, with a travel distance of 1.5, and a traveling time of 45, and delivery sharing is 3 in region B, i.e., a sum of 3, a time of 30, and a coverage of 1. The transportation sharing is “acceptable” with 3 in region B, i.e., a sum of 3, 2 vacant seats, no hand-overs, no packages handed over, a hand-over time of 0, 1 take-over, 3 packages taken over, and a take-over time of 3. The service start point is the hand-over point 2, the service start time is 108, and the final time required for delivery is 183.

The vehicle #3 of the third draft has a planned route of D→C, passing hand-over points 1 and 2, with a travel distance of 2.5, and a traveling time of 75, and delivery sharing is 3 in region C, i.e., a sum of 3, a time of 30, a coverage of 1. The transportation sharing is “acceptable” with 3 in region B and 3 in region C, i.e., a sum of 6, 1 vacant seat, 1 hand-over, 3 packages handed over, a hand-over time of 3, no take-overs, no packages taken over, and a take-over time of 0. The service start point is D, the service start time is 0, and the final time required for delivery is 108.

The vehicle #4 of the third draft has a planned route of D, passing hand-over point 1, with a travel distance of 1, and a traveling time of 30, and delivery sharing is 5 in region D, i.e., a sum of 5, a time of 50, and a coverage of 1. The transportation sharing is “acceptable” with 5 in region D, i.e., a sum of 5, 1 vacant seat, no hand-overs, no packages handed over, a hand-over time of 0, no take-overs, no packages taken over, and a take-over time of 0. The service start point is D, the service start time is 0, and the final time required for delivery is 80.

The vehicle #5 of the third draft has a planned route of D→E, passing hand-over point 1, with a travel distance of 3.5, and a traveling time of 105, and delivery sharing is 2 in region E, i.e., a sum of 2, a time of 20, and a coverage of 1. The transportation sharing is “acceptable” with 4 in region A and 2 in region E, i.e., a sum of 6, 1 vacant seat, 1 hand-over, 4 packages handed over, a hand-over time of 4, no take-overs, no packages taken over, and a take-over time of 0. The service start point is D, the service start time is 0, and the final time required for delivery is 129.

In the third draft, as shown in FIG. 12D, 5 vehicles in total are required, with a total travel distance of 12, and a total traveling time of 360, and delivery sharing is 4 at A, 3 at B, 3 at C, 5 at D, 2 at E, i.e., a total sum of 17, a total time of 170, a total coverage of 5, and a delivery efficiency of 1.42. The total transportation sharing is 24, with 8 at A, 6 at B, 3 at C, 5 at D and 2 at E. Moreover, the transportation sharing has 7 vacant seats in total, 2 hand-overs in total, 7 packages handed over in total, a total hand-over time of 7, 2 take-overs in total, 7 packages taken over in total, a total take-over time of 7, and a maximum value of a final time required for delivery of 183. The vehicle #1 of the fourth draft has a planned route of D→E, passing hand-over point 1, with a travel distance of 3.5, and a traveling time of 105, and delivery sharing is 5 in region D and 2 in region E, i.e., a sum of 7, a time of 70, a coverage of 2. The transportation sharing is “acceptable” with 5 in region D and 2 in region E, i.e., a sum of 7, no vacant seats, no hand-overs, no packages handed over, a hand-over time of 0, no take-overs, no packages taken over, and a take-over time of 0. The service start point is D, the service start time is 0, and the final time required for delivery is 175.

The vehicle #2 of the fourth draft has a planned route of D→C→A, passing hand-over points 1 and 2, with a travel distance of 4.5, and a traveling time of 135, and delivery sharing is 4 in region A, i.e., a sum of 4, a time of 40, and a coverage of 1. The transportation sharing is “acceptable” with 4 in region A, i.e., a sum of 4, 2 vacant seats, no hand-overs, no packages handed over, a hand-over time of 0, no take-overs, no packages taken over, and a take-over time of 0. The service start point is D, the service start time is 0, and the final time required for delivery is 175.

The vehicle #3 of the fourth draft has a planned route of D→C→B, passing hand-over points 1 and 2, with a travel distance of 4, and a traveling time of 120, and delivery sharing is 3 in region B and 3 in region C, i.e., a sum of 6, a time of 60, and a coverage of 2. The transportation sharing is “acceptable” with 3 in region B and 3 in region C, i.e., a sum of 6, 1 vacant seat, no hand-overs, no packages handed over, a hand-over time of 0, no take-overs, no packages taken over, and a take-over time of 0. The service start point is D, the service start time is 0, and the final time required for delivery is 180.

In the fourth draft, as shown in FIG. 12E, 3 vehicles in total are required, with a total travel distance of 12, and a total traveling time of 360, and delivery sharing is 4 at A, 3 at B, 3 at C, 5 at D, 2 at E, i.e., a total sum of 17, a total time of 170, a total coverage of 5, and a delivery efficiency of 1.42. The total transportation sharing is 17 with 4 at A, 3 at B, 3 at C, 5 at D and 2 at E. Moreover, the transportation sharing has 11 vacant seats in total, no hand-overs in total, no packages handed over in total, a total hand-over time of 0, no take-overs in total, no packages taken over in total, a total take-over time of 0, and a maximum value of a final time required for delivery of 180. From the calculated information for determining the vehicle dispatch candidate, the vehicle allocation plan determination unit 36 determines the vehicle allocation candidate based on the predetermined condition, from among the vehicle allocation candidates, i.e., the draft of the standard plan as well as the first to fourth drafts. Accordingly, it is possible to create the vehicle allocation plan suitable for the predetermined condition. For example, the vehicle allocation plan determination unit 36 determines the vehicle allocation plan based on at least one of the delivery efficiency (transportation efficiency) and the time required for delivery (time required for transportation), as the predetermined condition. For example, the vehicle allocation candidate having the highest delivery efficiency may be selected. In a case where there are several vehicle dispatch candidates having the same delivery efficiency, the vehicle dispatch candidate having the shortest time required for delivery is selected. Alternatively, the vehicle allocation candidate with the shortest time required for delivery may be selected, and in a case where there are several vehicle dispatch candidates having the same time required for delivery, the vehicle dispatch candidate with the highest delivery efficiency may be selected to create the vehicle allocation plan. Further, precondition other than the transportation efficiency and the time required for transportation may be employed as the predetermined condition. For example, in order to create the vehicle allocation plan, the vehicle dispatch candidate may be selected in consideration of precondition such as a period of time of transportation.

One example of a method of selecting the vehicle allocation plan from among the vehicle allocation candidates, e.g., the draft of the standard plan as well as the first to fourth drafts, is selecting the draft with higher delivery efficiency as compared to the draft of the standard plan. If no draft has higher delivery efficiency than the draft of the standard plan, the draft of the standard plan is selected.

In a case where the reservation for a passenger has been received, the draft satisfying reservation condition are selected. In a case where there are several drafts satisfying the reservation condition, the draft with the shortest time required for transportation is selected.

If no draft satisfies the reservation condition, the fourth draft is selected to dispatch a vacant vehicle for riding.

In the embodiment stated above, the vehicle allocation plan server 12 and the service management server 14 are different servers, but the present disclosure is not limited thereto and the vehicle allocation plan server 12 may have functions of the service management server 14.

Further, in the embodiment stated above, the taxi 26 and the bus 28 are vehicles to be dispatched, but the present disclosure is not limited thereto. For example, vehicles of a transportation company or private vehicles, registered in advance, may be used.

Further, the processes executed by each unit of the vehicle allocation plan server 12 are implemented by software run by executing a program in the embodiment stated above, but the present disclosure is not limited thereto. For example, the processes may be implemented by hardware such as a graphics processing unit (GPU), an application specific integrated circuit (ASIC), and a field programmable gate array (FPGA). Alternatively, the processes may be implemented by a combination of software and hardware. Further, in the case of the software, the program may be stored in various types of storage media and distributed.

Furthermore, the present disclosure is not limited thereto. Various modifications and alterations may be made without departing from the gist of the present disclosure. For example, unnecessary steps may be omitted, new steps may be added, or the process order may be changed without departing from the scope of the present disclosure.

What is claimed is:

1. A vehicle allocation plan device comprising:
an acceptance unit configured to accept transportation request information including respective locations of a departure point and an arrival point for a transportation target; and
a creation unit configured to:
acquire vehicle information including location information of a plurality of vehicles, each of which travels in each of a plurality of regions within a range from the departure point to the arrival point; and
create a vehicle allocation plan such that a vehicle is located, within a predetermined time range, in an area where the plurality of regions are in contact with each other, based on the acquired location information and the transportation request information which is accepted by the acceptance unit.

2. The vehicle allocation plan device according to claim 1, wherein:
the vehicle is a taxi; and
the creation unit is configured to create the vehicle allocation plan such that, in a case where the transportation target is a person, the taxi transports the person beyond a region at which the taxi offers services and which includes the departure point, and in a case where the taxi returns from the arrival point to the region including the departure point, the transportation target is limited to goods.

3. The vehicle allocation plan device according to claim 1, wherein
the creation unit is configured to derive a plurality of vehicle dispatch candidates, each of which having a vehicle and a route, determined for transportation according to a predetermined precondition, and create the vehicle allocation plan by determining, based on a predetermined condition, a vehicle dispatch candidate from among the derived vehicle dispatch candidates.

4. The vehicle allocation plan device according to claim 3, wherein the creation unit is configured to determine the vehicle dispatch candidate from among the plurality of vehicle dispatch candidates based on at least one of transportation efficiency and a time required for transportation, as the predetermined condition.

5. A vehicle allocation plan system comprising:
the vehicle allocation plan device according to claim 1;
a client terminal that generates transportation request information and transmits the transportation request information to the vehicle allocation plan device; and
a vehicle-side terminal mounted on a vehicle and having functions of transmitting vehicle information and receiving a vehicle allocation plan created by the vehicle allocation plan device.

6. A vehicle allocation plan program causing a computer to function as each component of the vehicle allocation plan device according to claim 1.
